(19) United States
(12) Patent Application Publication
(10) Pub. No.: US 2006/0136195 A1
(43) Pub. Date: Jun. 22, 2006

(54) Text grouping for disambiguation in a speech application

(75) Inventors: Ciprian Agapi, LakeWorth, FL (US); Vanessa V. Michelini, Boca Raton, FL (US); Brent D. Metz, Delray Beach, FL (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 11/022,466

(22) Filed: Dec. 22, 2004

(51) Int. Cl. G06F 17/28

(52) U.S. Cl. 704/4

(57) ABSTRACT

A method, system and apparatus for text grouping in a disambiguation process. A text grouping method for use in a disambiguation process can include producing a phonetic representation for each entry in a text list, sorting the list according to the phonetic representation, grouping phonetically similar entries in the list, and providing the sorted list with the groupings to the disambiguation process. The producing step can include producing a phonetic representation for each word in the text list. The producing step also can include producing a phonetic representation for each phrase in the text list.

### BACKGROUND OF THE INVENTION

1. Statement of the Technical Field

The present invention relates to the field of speech recognition systems, and more particularly to disambiguation methods for speech recognition systems.

2. Description of the Related Art

Speech recognition systems perform a critical role in commerce by providing an essential reduction in operating costs in terms of avoiding the use of expensive human capital in processing human speech. Generally, speech recognition systems include speech recognition and text-to-speech processing capabilities coupled to a script defining a call flow. Consequently, speech recognition systems can be utilized to provide a voice interactive experience for speakers just as if a live human had engaged in a person-to-person conversation.

Speech recognition systems have proven particularly useful in adapting Web based information systems and telephony applications to the audible world of voice processing. In particular, while Web based information systems have been particularly effective in collecting and processing information from end users through the completion of fields in an on-line form, the same also can be said of speech recognition systems. In particular, Voice XML and equivalent technologies have provided a foundation upon which Web forms have been adapted to voice. Consequently, speech recognition systems have been configured to undertake complex data processing through forms based input just as would be the case through a conventional Web interface.

Speech recognition systems permit end users facilitated access to a vast quantity of information. In the course of requesting access to information through a speech recognition system, however, ambiguities can arise. The typical ambiguity encountered in the use of a speech recognition system arises when end user input of a name results in multiple records matching the end user supplied name. In the case of a visual interface, the three matching records can be visually rendered concurrently along with additional disambiguating fields without delay and the end user can disambiguate the selection with a simple keyboard or mouse action. In the context of the audible user interface of a speech recognition system, however, the end user must be presented with the list of matching records in sequence.

Notably, an ambiguity problem further can arise when encountering homophones in speech. As it is well known in the linguistic arts, homophones are words which are spelled differently from one another, but which are pronounced similarly. Manual disambiguation methods exist currently whereby a programmer can search and locate homophonic words and subsequently group the words together programmatically to present a disambiguation prompt to the end user. Examples include an n-best algorithm which returns a list of possible matches for a spoken word or sentence. In this case, however, the control remains with the speech processing engine and not with the application utilizing the speech processing engine. Consequently, application developers must trust the engine implementation of the disambiguation method in the formulation of the list of matches.

### SUMMARY OF THE INVENTION

The present invention addresses the deficiencies of the art in respect to speech disambiguation and provides a novel and non-obvious method, system and apparatus for text grouping in a disambiguation process. A text grouping method for use in a disambiguation process can include producing a phonetic representation for each entry in a text list, sorting the list according to the phonetic representation, grouping phonetically similar entries in the list, and providing the sorted list with the groupings to the disambiguation process. The producing step can include producing a phonetic representation for each word in the text list. The producing step also can include producing a phonetic representation for each phrase in the text list.

In one aspect of the invention, the method further can include flagging each grouping in the list as requiring disambiguation. In another aspect of the invention, the method further can include, for each similar phoneme across different entries in the grouping, substituting the similar phoneme with a first occurrence of the phoneme. Finally, in yet another aspect of the invention, the method further can include storing the similar phoneme in a temporary variable.

A speech system configured for disambiguation can include a speech application configured for coupling to a speech engine, a disambiguation processor associated with the speech application, and text grouping logic programmed to produce an optimized grammar for use by the disambiguation processor in disambiguating similar sounding text. The similar sounding text can include homophonic words. Also, the similar sounding text can include oronymic phrases. In either case, the text grouping logic can include logic to sort and group entries in a text list according to a phonetic representation for each of the entries.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a speech system configured for speech disambiguation through text grouping according to the present invention; and,

FIG. 2 is a flow chart illustrating a process for disambiguating speech through text grouping based upon a phonetic representation of homophonic words.

### DETAILED DESCRIPTION OF THE PREFERRED EMBODIMENTS

The present invention is a method, system and apparatus for text grouping for speech disambiguation. In accordance with the present invention, text, including words or phrases, can be reduced to a phonetic representation and sorted phonetically. Subsequently, comparable adjacent phonetic representations of homophonic words can be grouped into homonym groups. Once the homonym groups have been produced, a grammar can be generated for the text in the groups, which can account for the homonym groups and the grammar can be applied in a disambiguation process such that the disambiguation process can be data and context specific without relying upon speech engine specific disambiguation design choices.

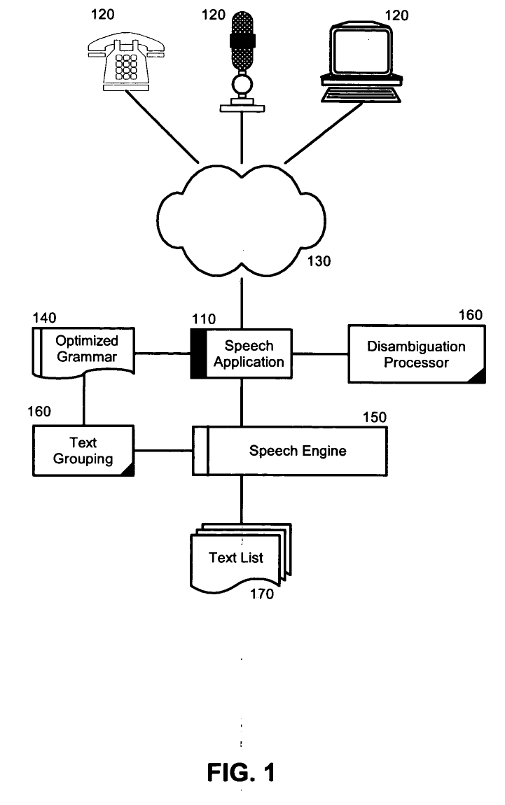

In further illustration, FIG. 1 is a schematic illustration of a speech system configured for speech disambiguation through text grouping according to the present invention. The system can include a speech application 110 coupled to one or more audio input devices 120 which can include telephonic input devices, direct audio input devices and other computing platforms. The coupling of the speech application 110 to the audio input devices 120 can occur directly over a wireless or wirebound link, or indirectly over a computer communications network 130, or any combination thereof.

The speech application 110 can configured for interoperation with a speech engine 150 able to process speech based upon text data 170, such as a list of words or phrases. The speech application 110 further can process speech input and output based upon an optimized speech grammar 140. Also, a disambiguation processor 160 further can be interoperably coupled to the speech application to resolve ambiguities among multiple speech elements, including both speech input and speech output. Importantly, to facilitate the disambiguation of homophonic data, a homophonic grammar generation process 160 can be interoperably coupled to the speech engine 150 to produce the optimized speech grammar 140 for use by the speech application 110.

Notably, within the speech application 110, the optimized grammar 140 can assist the speech application 110 in recognizing spoken input. Yet, without a human grouping of homophones for later disambiguation, the speech application 110 will match the first occurrence of a homophone in a grammar—an automatic selection which might be incorrect. Advantageously, in the present invention static and dynamic lists of data can be constructed and maintained that can be used as the optimized grammar 140 to recognize speech from a user.

The sorting process can be based on the phonetic representation of the text entries in the list. Using the phonetic representation, clusters of homophones can be formed. Optionally, clusters of oronyms can be identified which essentially are similarly “sounding” phrases as compared to similarly sounding individual words. In a subsequent step, the disambiguation process can present these homophonic, or ononymic, clusters dynamically to a user for disambiguation. By doing so, a very laborious, time-consuming and error-prone human intervention can be avoided and greater efficiencies can be gained.

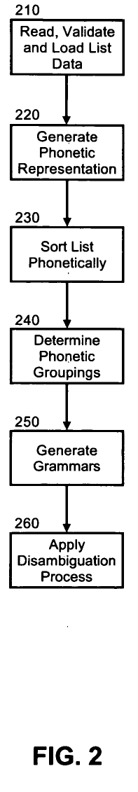

In further illustration, FIG. 2 is a flow chart illustrating a process for disambiguating speech through text grouping based upon a phonetic representation of homophonic words. Beginning in block 210, list entries including homophonic words or oronymic phrases can be loaded and validated for processing. In block 220, a phonetic representation can be created for text entries in the list data. For example, the text “berth” can be reduced to “B AXR TH”, the text “beat” can be reduced to “B IY TD”, and the text “feat” can be reduced to “F IY TD”. Similarly, the text “birth” can be reduced to “B AXR TH”, the text “beet” can be reduced to “B IY TD”, and the text “feet” can be reduced to “F IY TD”.

In block 230, the list data can be sorted phonetically thereby producing adjacencies in the list between different homophones. Subsequently, in block 240 the homophonic groupings can be identified. In this regard, for each grouping, phonemes or phonetic groups that are similar or close equivalents can be replaced to match the first occurrence in the grouping. This step can employ a predefined set of rules, which determine close phonetic equivalency. These phonetic equivalents can be language specific, and can take into account acoustic confusability and pronunciation critical features.

As an example, the phoneme “D” can be considered a close equivalent to the phoneme “T” and the phoneme “AX” can be considered the close equivalent to the phoneme “AE”. In any case, temporary variables can be used to store the original phonetic representation to permit the distinguishing of different words or phrases in the grouping. The groupings themselves can be separated from other text entries in the list or other groupings by inserting a blank line at each end of the grouping. Moreover, each entry in the grouping can be flagged as an entry requiring disambiguation. Subsequently, in block 250 an optimized grammar can be generated from the modified and grouped list data and in block 260 a disambiguation process can be applied based upon the groupings in the course of operation of the speech application where required.

Specifically, with the text of equivalent phonetic representation having been grouped together, the speech application can traverse the listing in response to speech input to locate desired information. When the desired information is found within a grouping indicated by the flagging of the entry, a disambiguation process can load the entries in the grouping and process the entries in the course of a disambiguation flow in order to determine an appropriate and desired entry. Otherwise, no disambiguation will be required.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A text grouping method for use in a disambiguation process, the method comprising the steps of:
producing a phonetic representation for each entry in a text list;
sorting said list according to said phonetic representation;
grouping phonetically similar entries in said list; and,
providing said sorted list with said groupings to the disambiguation process.

2. The method of claim 1, wherein said producing step comprises the step of producing a phonetic representation for each word in said text list.

3. The method of claim 1, wherein said producing step comprises the step of producing a phonetic representation for each phrase in said text list.

4. The method of claim 1, further comprising the step of flagging each grouping in said list as requiring disambiguation.

5. The method of claim 1, further comprising the step of, for each similar phoneme across different entries in said grouping, substituting said similar phoneme with a first occurrence of said phoneme.

6. The method of claim 5, further comprising the step of storing said similar phoneme in a temporary variable.

7. A speech system configured for disambiguation, the system comprising:
a speech application configured for coupling to a speech engine;
a disambiguation processor associated with said speech application; and,
text grouping logic programmed to produce an optimized grammar for use by said disambiguation processor in disambiguating similar sounding text.

8. The system of claim 7, wherein said similar sounding text comprises homophonic words.

9. The system of claim 7, wherein said similar sounding text comprises oronymic phrases.

10. The system of claim 7, wherein said text grouping logic comprises logic to sort and group entries in a text list according to a phonetic representation for each of said entries.

11. A machine readable storage having stored thereon a computer program for text grouping in a disambiguation process, the computer program comprising a routine set of instructions which when executed by a machine causes the machine to perform the steps of:
producing a phonetic representation for each entry in a text list;
sorting said list according to said phonetic representation;
grouping phonetically similar entries in said list; and,
providing said sorted list with said groupings to the disambiguation process.

12. The machine readable storage of claim 11, wherein said producing step comprises the step of producing a phonetic representation for each word in said text list.

13. The machine readable storage of claim 11, wherein said producing step comprises the step of producing a phonetic representation for each phrase in said text list.

14. The machine readable storage of claim 11, further comprising an additional set of instructions which when executed by the machine causes the machine to further perform the step of flagging each grouping in said list as requiring disambiguation.

15. The machine readable storage of claim 11, further comprising an additional set of instructions which when executed by the machine causes the machine to further perform the step of, for each similar phoneme across different entries in said grouping, substituting said similar phoneme with a first occurrence of said phoneme.

16. The machine readable storage of claim 15, further comprising an additional set of instructions which when executed by the machine causes the machine to further perform the step of storing said similar phoneme in a temporary variable.
